(19) United States
(12) Patent Application Publication
(10) Pub. No.: US 2015/0029140 A1
(43) Pub. Date: Jan. 29, 2015

(54) PORTABLE DISPLAY DEVICE

(71) Applicants: Chwen-Tay Hwang, Hsin-Chu (TW); Wei-Cheng Huang, Hsin-Chu (TW)

(72) Inventors: Chwen-Tay Hwang, Hsin-Chu (TW); Wei-Cheng Huang, Hsin-Chu (TW)

(73) Assignee: CORETRONIC CORPORATION, Hsin-Chu (TW)

(21) Appl. No.: 14/260,291

(22) Filed: Apr. 24, 2014

(30) Foreign Application Priority Data
Jul. 24, 2013 (TW) 102126506

(51) Int. Cl. G09G 5/10; G06F 3/044; G06F 3/042

(52) U.S. Cl. CPC G09G 5/10; G06F 3/0421; G06F 3/044
USPC 345/174; 345/173; 345/175

(57) ABSTRACT

A portable display device that includes a casing, a pico-projection module, a first display screen, and a touch module is provided. The pico-projection module is located in the casing and capable of providing a first image light beam. The first display screen is located on the casing, and the pico-projection module is configured to project the first image light beam onto the first display screen. The touch module is located on the first display screen.

### CROSS-REFERENCE TO RELATED APPLICATION

This application claims the priority benefit of Taiwan application serial no. 102126506, filed on Jul. 24, 2013. The entirety of the above-mentioned patent application is hereby incorporated by reference herein and made a part of this specification.

### BACKGROUND OF THE INVENTION

1. Field of the Invention

The invention relates to a display device and more particularly to a portable display device.

2. Description of Related Art

With the current development of science and technologies, easy-to-carry portable display devices (e.g., smart mobile phones and tablet PCs) with user-friendly interfaces have been indispensible to our daily lives. In general, a portable display device includes a backlight module and a liquid crystal module. The backlight module is located on one side of the liquid crystal module for providing an illumination light beam to the liquid crystal module. The illumination light beam that is emitted from the backlight module and passes through the liquid crystal module is converted into an image light beam. The image light beam forms an image which is then displayed.

However, the backlight module and the liquid crystal module consume significant power, and thus the weight and the power consumption of the portable display device both increase when it is intended to satisfy the user's requirement for a large-sized screen of the portable display device. Besides, in a normal portable display device, the costs of the backlight module and the liquid crystal module account for a great proportion of the total costs.

U.S. Patent Publication no. 2005/0259322 discloses a touch-enabled projection screen. U.S. Patent Publication no. 2013/0016324 discloses a wide field-of-view projector. U.S. Patent Publication no. 2008/0136973 discloses a laptop computer.

### SUMMARY OF THE INVENTION

The invention is directed to a portable display device with lighter weight, lower power consumption, and less costs in comparison with those of a conventional portable display device. This is because the portable display device described herein does not require the expensive and heavy liquid crystal module and backlight module that consume significant power.

Additional aspects and/or advantages of the invention will be set forth in part in the description which follows and, in part, will be obvious from the description, or may be learned by practice of the invention.

An embodiment of the invention provides a portable display device that includes a casing, a pico-projection module, a first display screen, and a touch module. The pico-projection module is located in the casing and capable of providing a first image light beam. The first display screen is located on the casing, and the pico-projection module is configured to project the first image light beam onto the first display screen. The touch module is located on the first display screen.

According to an embodiment of the invention, the first image light beam from the pico-projection module is transmitted in the casing to the first display screen.

According to an embodiment of the invention, the pico-projection module includes an illumination system, a light valve, a plurality of optical elements (e.g., lenses), and an imaging lens. The illumination system is capable of emitting an illumination light beam and includes a light emitting diode (LED), a laser source, or a composite light source having the laser source and a fluorescent module. The light valve is located on a transmission path of the illumination light beam to convert the illumination light beam into the first image light beam. Here, the first image light beam is an image light beam. The imaging lens is located on a transmission path of the first image light beam and between the light valve and the first display screen.

According to an embodiment of the invention, the pico-projection module includes a light source module and a scanner module. The light source module is capable of emitting the first image light beam. The scanner module is located on a transmission path of the first image light beam and is capable of scanning the first image light beam onto different locations on the first display screen.

According to an embodiment of the invention, the first display screen includes a combination of a Fresnel lens and a lenticular lens array, a diffuser plate, or a diffractive plate.

According to an embodiment of the invention, the first display screen includes a fluorescent layer. When the first image light beam irradiates the fluorescent layer, the first image light beam excites the fluorescent layer, so as to generate a second image light beam.

According to an embodiment of the invention, the light source module includes a laser light source.

According to an embodiment of the invention, a thickness of the casing at locations from one end of the casing close to the pico-projection module to the other end of the casing away from the pico-projection module remains substantially the same, or the thickness of the casing gradually decreases from the one end of the casing close to the pico-projection module to the other end of the casing away from the pico-projection module.

According to an embodiment of the invention, the portable display device further includes a reflection element capable of reflecting the first image light beam from the pico-projection module to the first display screen.

According to an embodiment of the invention, a thickness of the casing gradually decreases from one end of the casing close to the reflection element to the other end of the casing close to the pico-projection module.

According to an embodiment of the invention, the pico-projection module and the reflection element are located on two opposite inner sides or on one inner side of the casing.

According to an embodiment of the invention, the reflection element is a plane mirror, a convex mirror, a concave mirror, a columnar convex minor, or a columnar concave mirror.

According to an embodiment of the invention, the casing includes a protrusion in which the pico-projection module is located.

According to an embodiment of the invention, the pico-projection module is located on one inner side of the casing or in an inner corner of the casing.

According to an embodiment of the invention, the portable display device further includes a steering component. The pico-projection module is rotatably connected to the casing through the steering component and configured to rotate to an inner projection location and an outer projection location. When the pico-projection module rotates to the inner projection location, the first image light beam from the pico-projection module is projected onto the first display screen, and when the pico-projection module rotates to the outer projection location, the first image light beam from the pico-projection module is projected out of the casing.

According to an embodiment of the invention, the portable display device further includes a light emitter and a light receiver. The light emitter is capable of emitting a third light beam to a region, and the first image light beam is projected on the region located outside the casing. The light receiver is capable of sensing a change of the third light beam to obtain a location of an object relative to the region on which the first image light beam is projected.

According to an embodiment of the invention, the portable display device further includes a polarizing beam splitter (PBS). The pico-projection module is configured to alternately project the first image light beam and a fourth image light beam, and a polarization state of the first image light beam is different from a polarization state of the fourth image light beam. The first image light beam is reflected by the PBS to the first display screen, and the fourth image light beam is projected out of the casing after passing through the PBS.

According to an embodiment of the invention, the portable display device further includes an optical compensation element. The fourth image light beam from the PBS is transmitted through the optical compensation element and projected out of the casing, and the optical compensation element is capable of compensating image aberration generated when the fourth image light beam is projected out of the casing.

According to an embodiment of the invention, the portable display device further includes a light emitter and a light receiver. The light emitter is capable of emitting a fifth light beam to a region, and the fourth image light beam is projected on the region located outside the casing. The light receiver is capable of sensing a change of the fifth light beam to obtain a location of an object relative to the region on which the fourth image light beam is projected.

According to an embodiment of the invention, the portable display device further includes a second display screen configured to be accommodated in the casing or unfolded out of the casing. When the second display screen is accommodated in the casing, the pico-projection module projects the first image light beam to the first display screen, and when the second display screen is unfolded out of the casing, the first image light beam is projected onto the first display screen and the second display screen.

According to an embodiment of the invention, the touch module is a capacitive touch panel.

According to an embodiment of the invention, the touch module is an optical waveguide touch module and includes a light emitter, a light guide plate (LGP), and a light detector. The light emitter is capable of emitting a detection light beam. The LGP is located on a transmission path of the detection light beam. The light detector is located on the transmission path of the detection light beam from the LGP. When an object is in contact with the optical waveguide touch module, the object changes the detection light beam transmitted in the LGP, and the light detector detects the detection light beam changed by the object.

According to an embodiment of the invention, the touch module is an optical curtain touch module and includes a light emitting module and a light reception module. The light emitting module is located on one side of the first display screen and emits a detection light beam transmitted in front of the first display screen. The light reception module is located on another side of the first display screen and is capable of receiving the detection light beam.

According to an embodiment of the invention, the touch module is an optical scanning touch module and includes at least one scanner light source and a light receiver. The scanner light source is located next to the first display screen and is capable of emitting a detection light beam, and the detection light beam scans space in front of the first display screen. The light receiver is located next to the first display screen to detect the detection light beam from the space in front of the first display screen. When an object is in contact with or approaches the first display screen, the light receiver detects the detection light beam reflected by the object.

According to an embodiment of the invention, the portable display device further includes a transparent solar panel located on one side of the first display screen and on a transmission path of the first image light beam.

According to an embodiment of the invention, the portable display device further includes a solar panel located on an inner side of the casing opposite to the first display screen.

In view of the above, the portable display device described in the embodiments of the invention may have at least one of the following advantages. In the portable display device, the pico-projection module located in the casing projects an image onto a display screen, and thereby the conventional backlight module and the conventional liquid crystal module may be replaced. As such, the resultant portable display device described herein may have light weight, low power consumption, and reduced manufacturing costs in comparison with the conventional portable display device.

Other features and advantages of the invention will be further understood from the further technological features disclosed by the embodiments of the invention wherein there are shown and described embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic front view illustrating a portable display device according to a first embodiment of the invention.

FIG. 1B is a schematic cross-sectional view illustrating the portable display device depicted in FIG. 1A.

FIG. 1C is a schematic view illustrating a pico-projection module of the portable display device depicted in FIG. 1A.

FIG. 1D is a partial cross-sectional view illustrating a touch module of the portable display device depicted in FIG. 1A.

FIG. 2 is a schematic view illustrating a pico-projection module of a portable display device according to a second embodiment of the invention.

FIG. 3A is a schematic front view illustrating a portable display device according to a third embodiment of the invention.

FIG. 3B is a schematic cross-sectional view illustrating the portable display device depicted in FIG. 3A.

FIG. 4A is a schematic front view illustrating a portable display device according to a fourth embodiment of the invention.

FIG. 4B is a schematic cross-sectional view illustrating the portable display device depicted in FIG. 4A.

FIG. 5A is a schematic front view illustrating a portable display device according to a fifth embodiment of the invention.

FIG. 5B is a schematic cross-sectional view illustrating the portable display device depicted in FIG. 5A.

FIG. 6A is a schematic front view illustrating a portable display device according to a sixth embodiment of the invention.

FIG. 6B is a schematic cross-sectional view illustrating the portable display device depicted in FIG. 6A.

FIG. 7A is a schematic front view illustrating a portable display device according to a seventh embodiment of the invention.

FIG. 7B is a schematic cross-sectional view illustrating the portable display device depicted in FIG. 7A.

FIG. 8A is a schematic front view illustrating a portable display device according to an eighth embodiment of the invention.

FIG. 8B is a schematic cross-sectional view illustrating the portable display device depicted in FIG. 8A.

FIG. 9A is a schematic front view illustrating a portable display device according to a ninth embodiment of the invention.

FIG. 9B is a schematic cross-sectional view illustrating the portable display device depicted in FIG. 9A.

FIG. 10A is a schematic front view illustrating a portable display device according to a tenth embodiment of the invention.

FIG. 10B is a schematic cross-sectional view illustrating the portable display device depicted in FIG. 10A.

FIG. 11A is a schematic front view illustrating a portable display device according to an eleventh embodiment of the invention.

FIG. 11B is a schematic cross-sectional view illustrating the portable display device depicted in FIG. 11A.

FIG. 12A is a schematic front view illustrating a portable display device according to a twelfth embodiment of the invention.

FIG. 12B is a schematic cross-sectional view illustrating the portable display device depicted in FIG. 12A.

FIG. 13A is a schematic view illustrating that a pico-projection module of a portable display device projects an image light beam to a first display screen according to a thirteenth embodiment of the invention.

FIG. 13B is a schematic view illustrating that the pico-projection module of the portable display device depicted in FIG. 13A projects an image light beam to the outside of a casing.

FIG. 14 is a schematic front view illustrating a portable display device according to a fourteenth embodiment of the invention.

FIG. 15A is a schematic view illustrating that a pico-projection module of a portable display device projects an image light beam to a first display screen according to a fifteenth embodiment of the invention.

FIG. 15B is a schematic view illustrating that the pico-projection module of the portable display device depicted in FIG. 15A projects an image light beam to the outside of a casing.

FIG. 16A is a schematic view illustrating that a pico-projection module of a portable display device projects an image light beam to a first display screen and to the outside of a casing according to a sixteenth embodiment of the invention.

FIG. 16B is a schematic cross-sectional view illustrating the portable display device depicted in FIG. 16A.

FIG. 17 is a schematic front view illustrating a portable display device according to a seventeenth embodiment of the invention.

FIG. 18A is a schematic view illustrating that a second display screen of a portable display device is accommodated in a casing according to an eighteenth embodiment of the invention.

FIG. 18B is a schematic view illustrating that the second display screen of the portable display device depicted in FIG. 18A is unfolded out of the casing.

FIG. 19A is a schematic front view illustrating a portable display device according to a nineteenth embodiment of the invention.

FIG. 19B and FIG. 19C are schematic views illustrating an operation of the touch module of the portable display device depicted in FIG. 19A.

FIG. 20A is a schematic front view illustrating a portable display device according to a twentieth embodiment of the invention.

FIG. 20B is a schematic view illustrating an operation of the touch module of the portable display device depicted in FIG. 20A.

FIG. 21 is a schematic view illustrating a portable display device according to a twenty-first embodiment of the invention.

FIG. 22A is a schematic side view illustrating a portable display device according to a twenty-second embodiment of the invention.

FIG. 22B is a schematic partial cross-sectional view illustrating the portable display device depicted in FIG. 22A.

FIG. 23 is a schematic cross-sectional view illustrating a portable display device according to a twenty-third embodiment of the invention.

### DESCRIPTION OF THE EMBODIMENTS

In the following detailed description of the embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

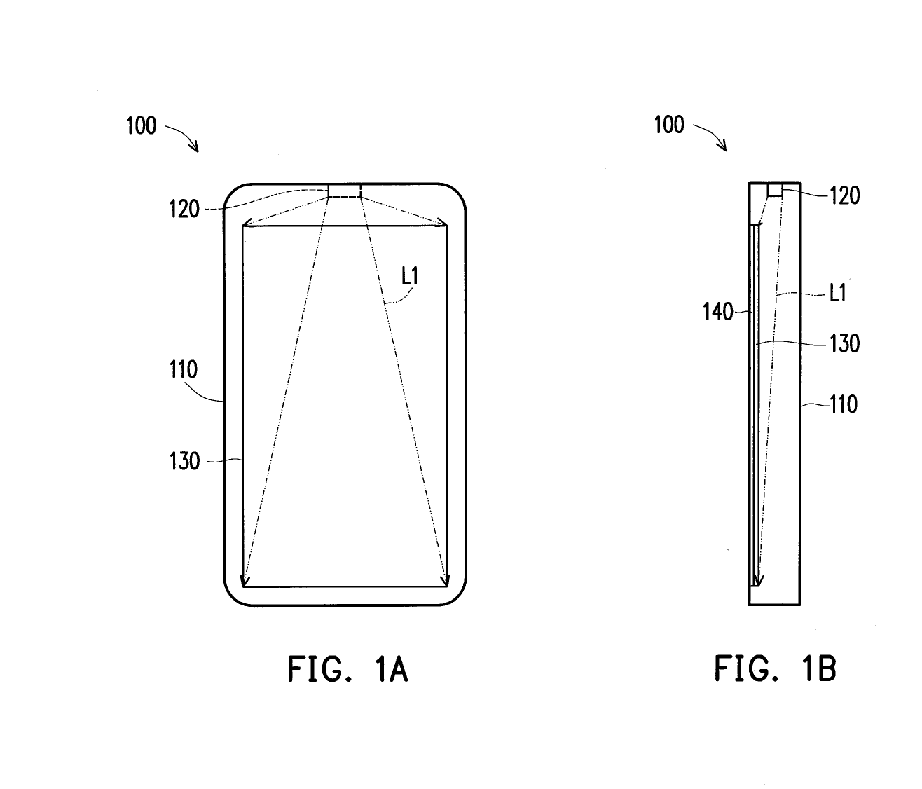

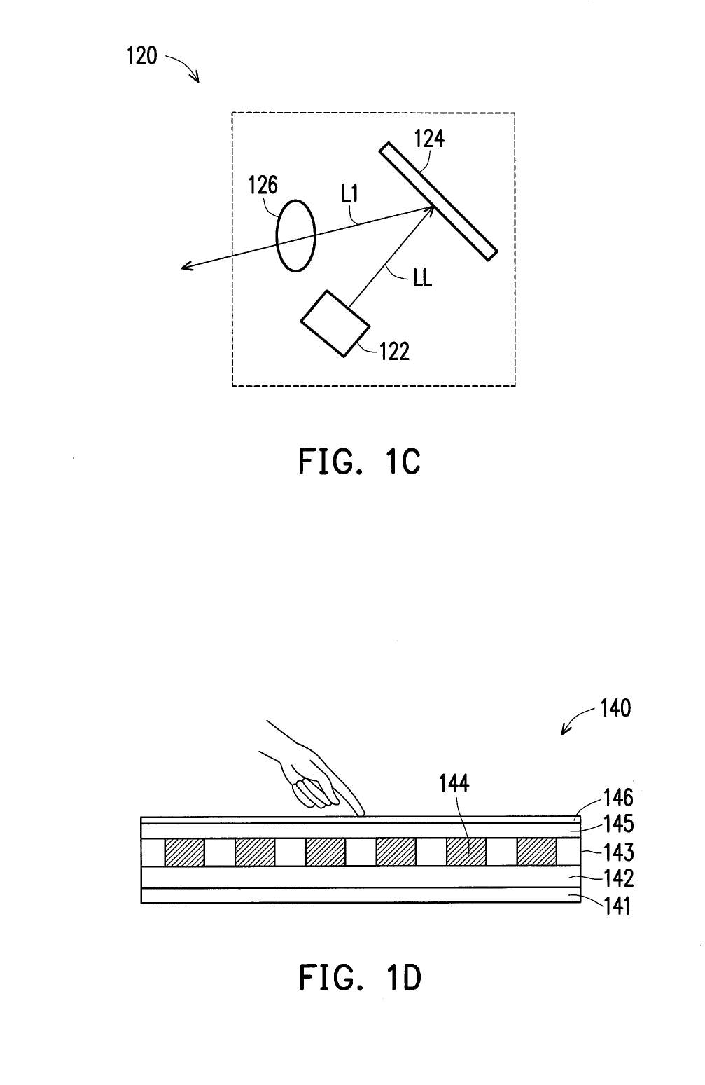

FIG. 1A is a schematic front view illustrating a portable display device according to a first embodiment of the invention. FIG. 1B is a schematic cross-sectional view illustrating the portable display device depicted in FIG. 1A. With reference to FIG. 1A and FIG. 1B, in the embodiment, the portable display device 100 is a tablet PC, for instance; however, in other embodiments of the invention, the portable display device 100 may be a smart mobile phone, a notebook computer, a personal digital assistant (PDA), an all-in-one computer, and so on.

The portable display device 100 described herein includes a casing 110, a pico-projection module 120, a first display screen 130, and a touch module 140. The pico-projection module 120 is located in the casing 110 and capable of providing a first image light beam L1. The first display screen 130 is located on the casing 110, and the pico-projection module 120 is configured to transmit the first image light beam L1 within the casing 110 to the first display screen 130. The touch module 140 is located on the first display screen 130.

To comply with the inner dimensions and configurations of the casing 110, the pico-projection module 120 provided in the embodiment has an ultra short throw (UST) system that clearly images the first image light beam L1 onto the first display screen 130. According to the embodiment of the invention, the first display screen 130 may be a diffuser plate, a diffractive plate, or a combination of a Fresnel lens and a lenticular lens array. The Fresnel lens serves to adjust non-parallel light beams to parallel light beams. When the lenticular lens array is employed together with the Fresnel lens, the light beams are converged, and light patterns are adjusted. The diffuser plate may diffuse the light beam in an even manner. The diffractive plate may adjust a direction of the light beam, such that the light beam may be transmitted to a designated location. Certainly, the type of the first display screen 130 is not limited to that described above.

FIG. 1C is a schematic view illustrating a pico-projection module of the portable display device depicted in FIG. 1A. In the embodiment, the pico-projection module 120 includes an illumination system 122, a light valve 124, and an imaging lens 126. The illumination system 122 serves to emit an illumination light beam LL. The light valve 124 is located on a transmission path of the illumination light beam LL, so as to convert the illumination light beam LL into the first image light beam L1 (an image light beam). The imaging lens 126 is located on a transmission path of the first image light beam L1 and between the light valve 124 and the first display screen 130, so as to project the first image light beam L1 onto the first display screen 130. In another embodiment of the invention, the pico-projection module 120 may further include a plurality of optical elements, e.g., lenses.

The illumination system 122 may be a light emitting diode (LED), a laser source, or a composite light source having the laser source and a fluorescent module (e.g., a rotatable phosphor wheel having different fan-shaped fluorescent regions). The light valve 124 may be a liquid-crystal-on-silicon (LCOS) panel, a digital micro-mirror device (DMD), or a liquid crystal display (LCD) panel. However, note that the type of the illumination system 122 and the type of the light valve 124 are not limited to those described above.

FIG. 1D is a partial cross-sectional view illustrating a touch module of the portable display device depicted in FIG. 1A. In the embodiment, the touch module 140 is a capacitive touch panel. The touch module 140 includes an electrode protection layer 141, a substrate 142 located on the electrode protection layer 141, a first electrode pattern layer 143 and a second electrode pattern layer 144 located above the substrate 142 and overlapped with each other, and a cover plate 146. The cover plate 146 is located above the first electrode pattern layer 143 and a second electrode pattern layer 144 through an optical adhesive layer 145 located between the cover plate 146 and the underlying first and second electrode pattern layers 143 and 144.

The first electrode pattern layer 143 and a second electrode pattern layer 144 are made of indium tin oxide (ITO). When an appropriate voltage is applied to the first electrode pattern layer 143 and a second electrode pattern layer 144, respectively, capacitance effects may be generated between the first electrode pattern layer 143 and a second electrode pattern layer 144. Hence, if a conductor (e.g., a human finger) is in contact with the touch module 140, the location of the conductor may be determined by detecting the capacitance change at specific locations.

In the portable display device 100 described herein, the pico-projection module 120 located in the casing 110 projects an image onto the first display screen 130, and thereby the conventional backlight module and the conventional liquid crystal module may be replaced. As such, the portable display device 100 may have light weight, low power consumption, reduced manufacturing costs, and small thickness in comparison with the conventional portable display device. In addition, according to an embodiment of the invention, the pico-projection module 120 of the portable display device 100 allows the brightness of the first display screen 130 to reach 420 nits and allows the contrast ratio to be at least 1200:1, and thus favorable display quality may be guaranteed.

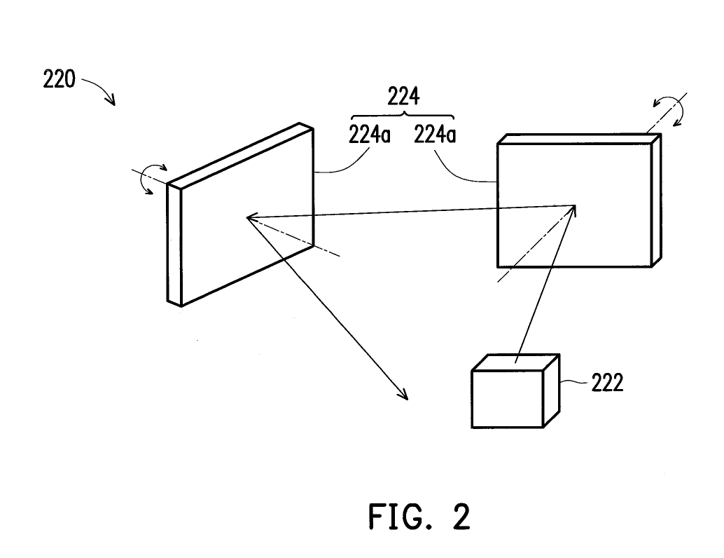

FIG. 2 is a schematic view illustrating a pico-projection module of a portable display device according to a second embodiment of the invention. According to the embodiment, another pico-projection module 220 that includes a light source module 222 and a scanner module 224 is provided. The light source module 222 serves to emit the first light beam L1; the scanner module 224 is located on a transmission path of the first image light beam L1 and is capable of scanning the first image light beam L1 onto different locations on the first display screen (not shown).

In the embodiment, the scanner module 224 includes two reflection mirrors 224a (e.g., an X mirror and a Y mirror) whose rotation axes are perpendicular to each other, and the first image light beam L1 is sequentially transmitted to the two reflection mirrors 224a and is then transmitted to the first display screen, so as to generate an image. In other embodiments, to reduce the volume of the scanner module 224, the rotation axes of the two reflection mirrors 224a may not be perpendicular to each other; alternatively, a reflection mirror that is not shown in the drawings and is able to rotate along two rotation axes perpendicular to each other may scan the first image light beam L1 onto different locations on the first display screen. According to the embodiment, the light source module 222 may include a laser light source, e.g., a laser diode, and the first image light beam L1 is a laser light beam.

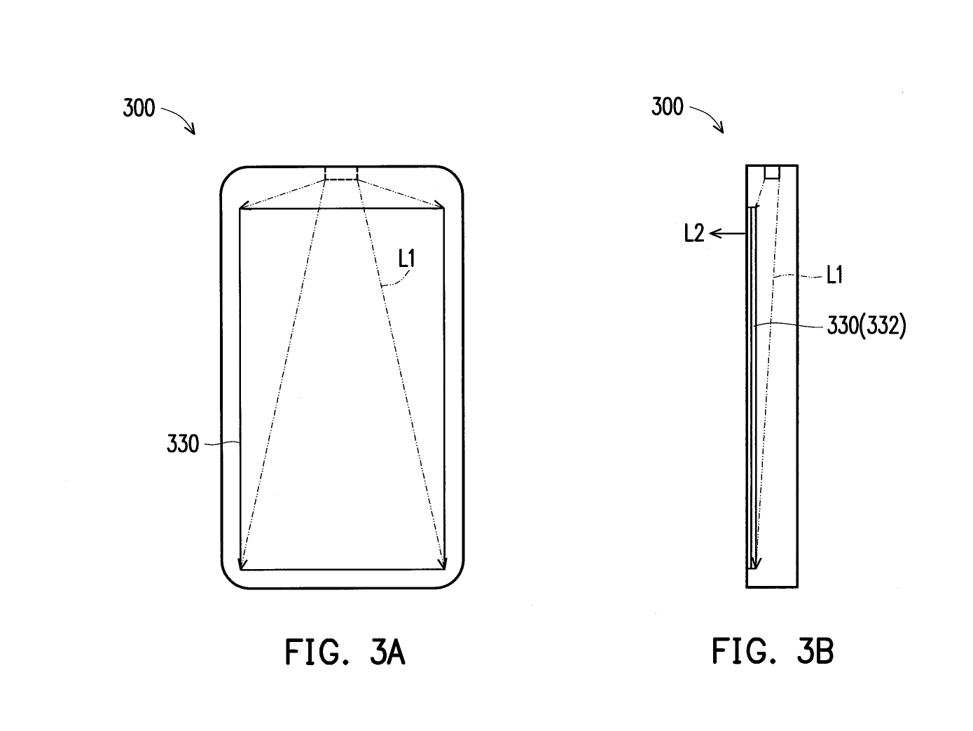

FIG. 3A is a schematic front view illustrating a portable display device according to a third embodiment of the invention. FIG. 3B is a schematic cross-sectional view illustrating the portable display device depicted in FIG. 3A. In the embodiment, the light source (not shown) is a laser light source. The first display screen 330 includes a fluorescent layer 332. When the first image light beam L1 irradiates the fluorescent layer 332, the first image light beam L1 excites the fluorescent layer 332, so as to generate a second image light beam L2. Here, a wavelength of the first image light beam L1 is shorter than a wavelength of the second image light beam L2.

The fluorescent layer 332 may include red, green, and blue phosphors. The first image light beam L1 having a certain wavelength irradiates the phosphor (with different colors) in the fluorescent layer 332, so as to excite the second image light beam L2 with several wavelengths. Alternatively, the fluorescent layer 332 may include phosphors in different colors, and the first image light beam L1 includes a plurality of sub-light beams with different wavelengths. These sub-light beams respectively irradiate the phosphors in different colors, so as to excite the second image light beam L2 having the required wavelength. At this time, the second image light beam L2 may also include a plurality of sub-light beams in different colors, and thereby color image frames are generated.

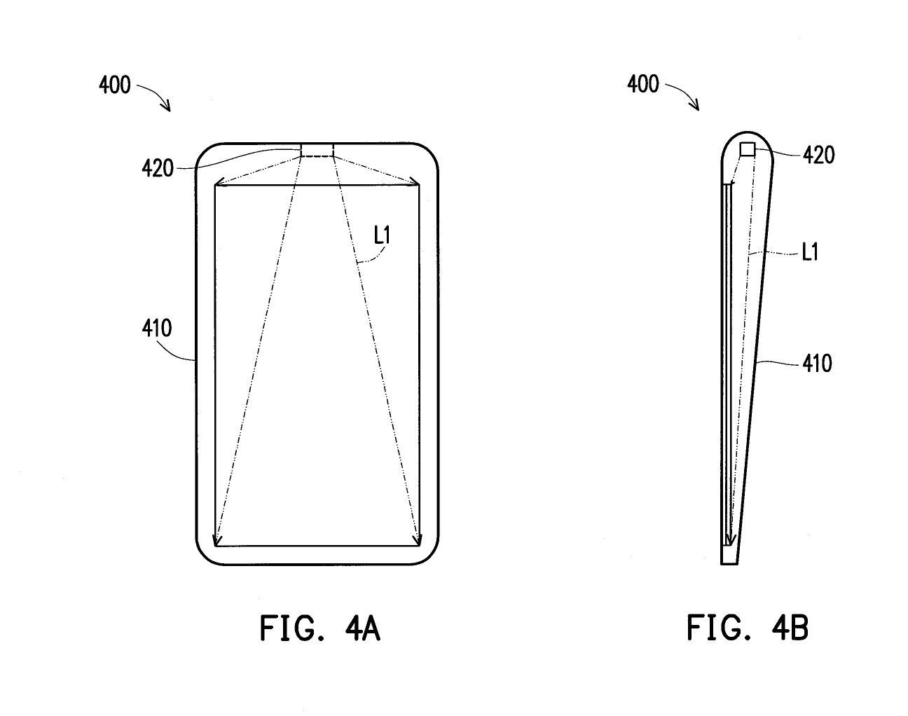

FIG. 4A is a schematic front view illustrating a portable display device according to a fourth embodiment of the invention. FIG. 4B is a schematic cross-sectional view illustrating the portable display device depicted in FIG. 4A. With reference to FIG. 4A and FIG. 4B, one of the differences between the portable display device 400 described in FIG. 4A and FIG. 4B and the portable display device 100 shown in FIG. 1B lies in that the casing 110 of the portable display device 100 shown in FIG. 1B is of a rectangular shape, i.e., the thickness of the casing 110 at locations from one end of the casing 110 close to the pico-projection module 120 to the other end of the casing 110 away from the pico-projection module 120 remains substantially the same. However, the casing 410 of the portable display device 400 is shaped as a wedge. Specifically, the thickness of the casing 410 of the portable display device 400 gradually decreases from one end of the casing 410 close to the pico-projection module 420 to the other end of the casing 410 away from the pico-projection module 420. The wedge-shaped casing 410 of the portable display device 400 contributes to the miniaturization of the portable display device 400, so as to thin the portable display device 400.

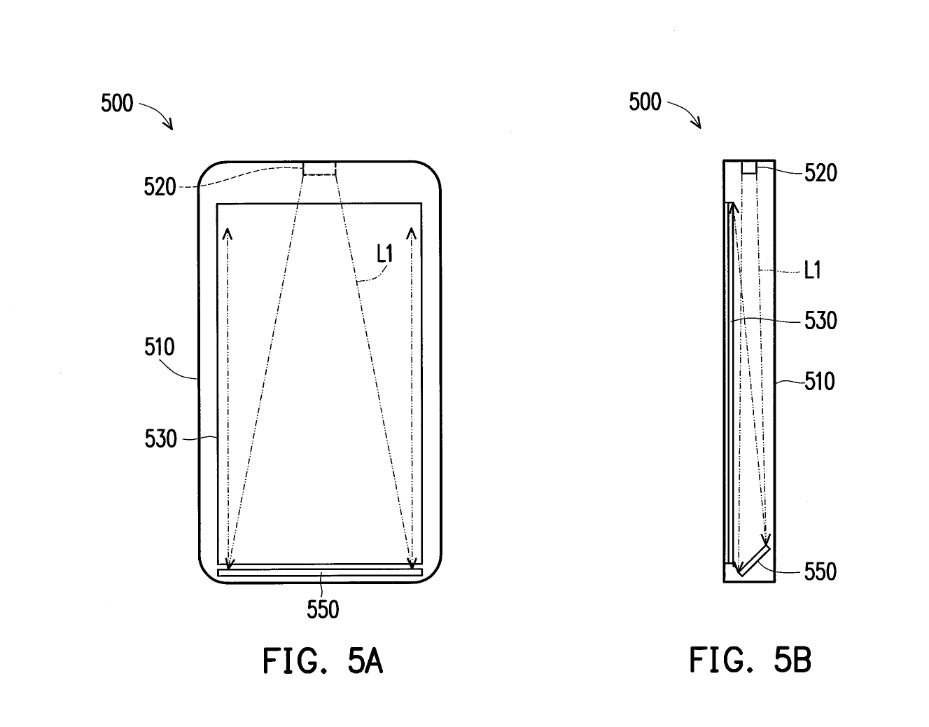

FIG. 5A is a schematic front view illustrating a portable display device according to a fifth embodiment of the invention. FIG. 5B is a schematic cross-sectional view illustrating the portable display device depicted in FIG. 5A. With reference to FIG. 5A and FIG. 5B, the portable display device 500 in the present embodiment further includes a reflection element 550, and the pico-projection module 520 and the reflection element 550 are located on two opposite inner sides of the casing 510. According to the embodiment, the reflection element 550 is a plane minor. The reflection element 550 is capable of reflecting the first image light beam L1 from the pico-projection module 520 to the first display screen 530, such that the first image light beam L1 may have a relatively long optical path.

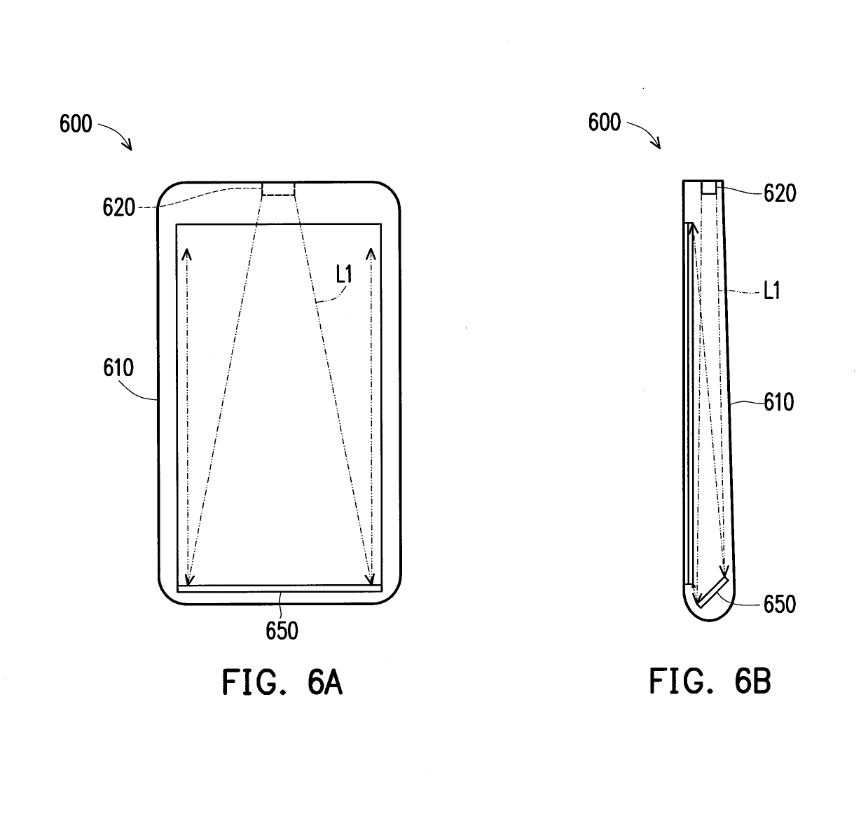

FIG. 6A is a schematic front view illustrating a portable display device according to a sixth embodiment of the invention. FIG. 6B is a schematic cross-sectional view illustrating the portable display device depicted in FIG. 6A. With reference to FIG. 6A and FIG. 6B, one of the differences between the portable display device 600 described in the embodiment and the portable display device 500 shown in FIG. 5B lies in that the thickness of the casing 510 of the portable display device 500 at locations from one end of the casing 510 close to the pico-projection module 520 to the other end of the casing 510 close to the reflection element 550 remains substantially the same. However, in the embodiment, the thickness of the casing 610 gradually decreases from one end of the casing 610 close to the reflection element 650 to the other end of the casing 610 close to the pico-projection module 620, and thereby the volume and the thickness of the portable display device 600 is reduced.

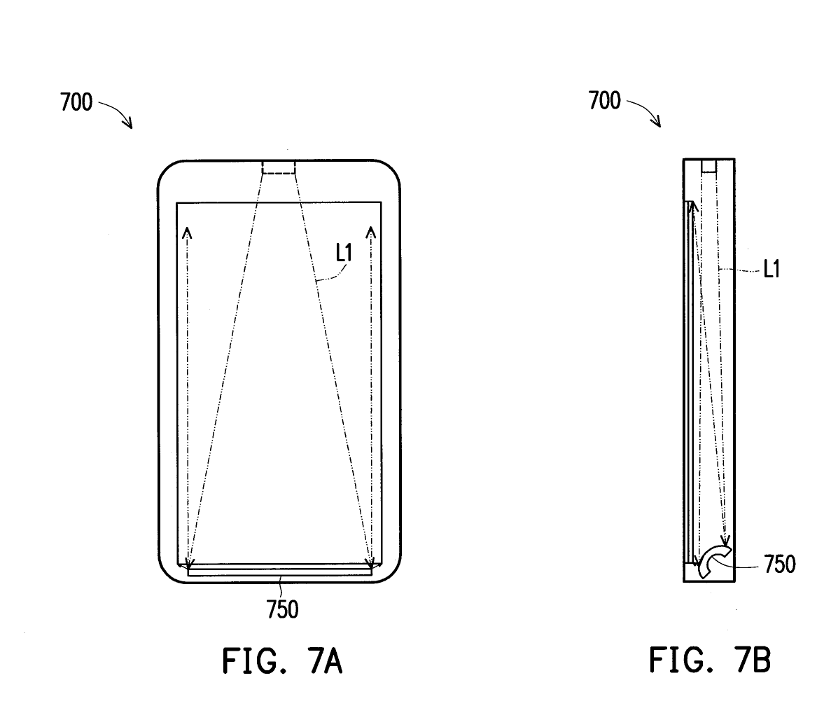

FIG. 7A is a schematic front view illustrating a portable display device according to a seventh embodiment of the invention. FIG. 7B is a schematic cross-sectional view illustrating the portable display device depicted in FIG. 7A. With reference to FIG. 7A and FIG. 7B, one of the differences between the portable display device 700 described in the embodiment and the portable display device 500 shown in FIG. 5A lies in that the reflection element 750 herein is a columnar convex mirror. Accordingly, the reflection element 750 observed at a view angle in FIG. 7A has a bar shape, while the reflection element 750 observed at a view angle in FIG. 7B has a convex surface. Certainly, the type of the reflection element 750 is not limited to that described herein, and the reflection element 750 in another embodiment may be a columnar concave mirror.

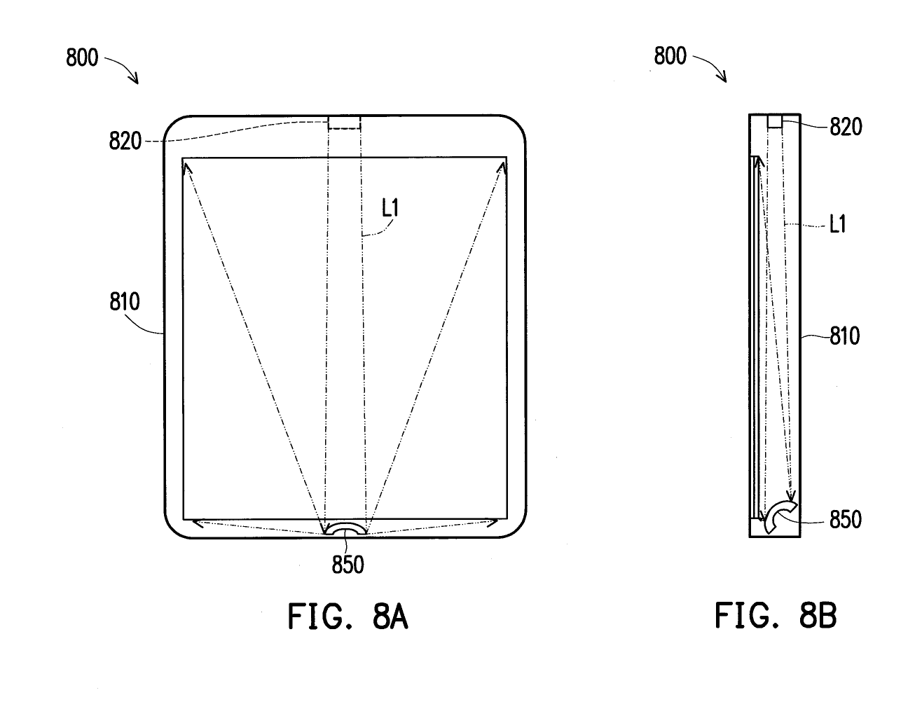

FIG. 8A is a schematic front view illustrating a portable display device according to an eighth embodiment of the invention. FIG. 8B is a schematic cross-sectional view illustrating the portable display device depicted in FIG. 8A. With reference to FIG. 8A and FIG. 8B, the reflection element 850 is a convex mirror. The convex surface of the reflection element 850 may be observed at both the view angle in FIG. 8A and the view angle in FIG. 8B. Certainly, the type of the reflection element 850 is not limited to that described herein, and the reflection element 850 in other embodiments may be an aspheric mirror, a free-form mirror, and so forth.

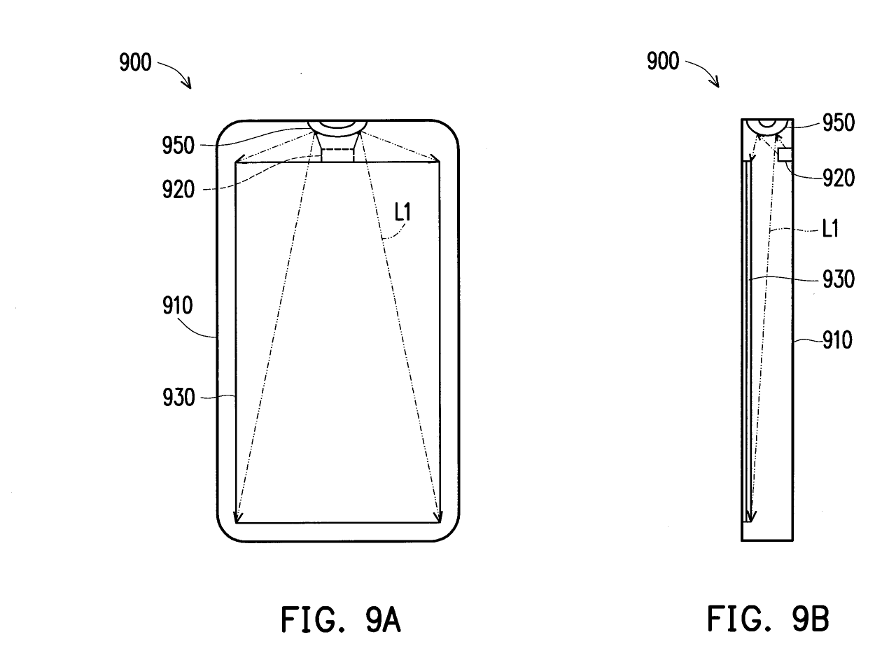

FIG. 9A is a schematic front view illustrating a portable display device according to a ninth embodiment of the invention. FIG. 9B is a schematic cross-sectional view illustrating the portable display device depicted in FIG. 9A. With reference to FIG. 9A and FIG. 9B, one of the differences between the portable display device 900 described in the embodiment and the portable display device 800 shown in FIG. 8A lies in that the pico-projection module 820 and the reflection element 850 in FIG. 8A are respectively located on two opposite inner sides of the casing 810. However, the pico-projection module 920 and the reflection element 950 are located on the same inner side of the casing 910. As long as the first image light beam L1 from the pico-projection module 920 is reflected to the first display screen 930, the relative locations of the pico-projection module 920 and the reflection element 950 are not limited to those described herein.

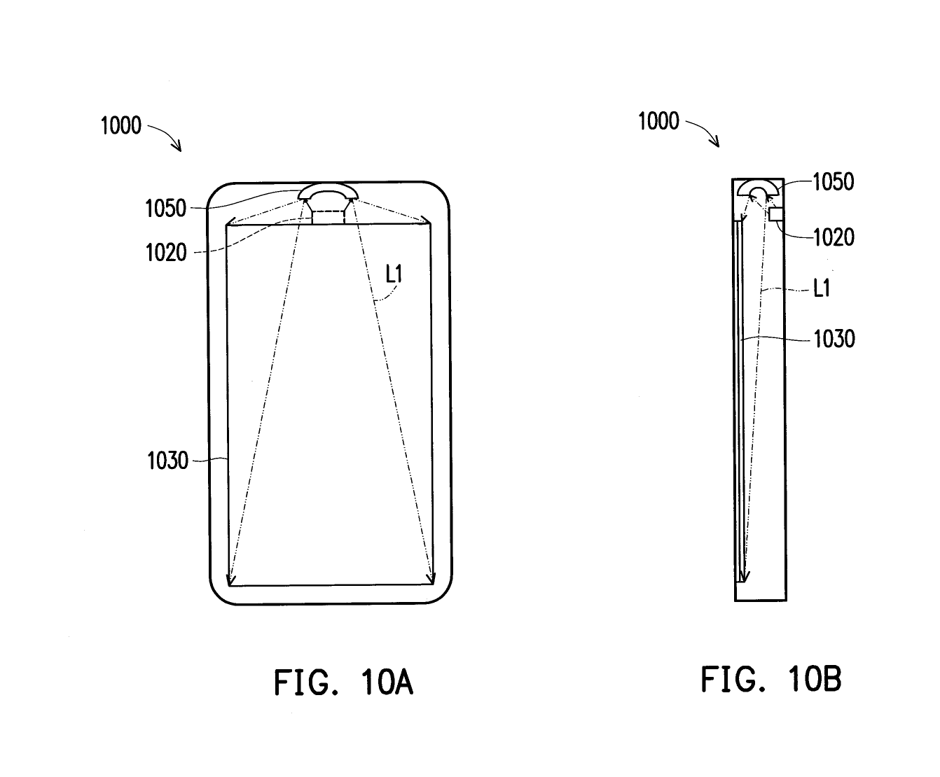

FIG. 10A is a schematic front view illustrating a portable display device according to a tenth embodiment of the invention. FIG. 10B is a schematic cross-sectional view illustrating the portable display device depicted in FIG. 10A. With reference to FIG. 10A and FIG. 10B, one of the differences between the portable display device 1000 described in the embodiment and the portable display device 900 shown in FIG. 9A lies in that the reflection element 950 in FIG. 9A is a convex mirror. However, according to the embodiment, the reflection element 1050 is a concave mirror. The type of the reflection element 1050 may be determined according to the type of the first image light beam L1 from the pico-projection module 1020. For instance, if the first image light beam L1 from the pico-projection module 1020 is scattered, the reflection element 1050 may be the concave mirror that is able to converge light beams (as described herein), so as to converge the scattered first image light beam L1. Certainly, as long as the first image light beam L1 from the pico-projection module 1020 may be reflected to the first display screen 1030, the type of the reflection element 1050 is not limited to that described herein.

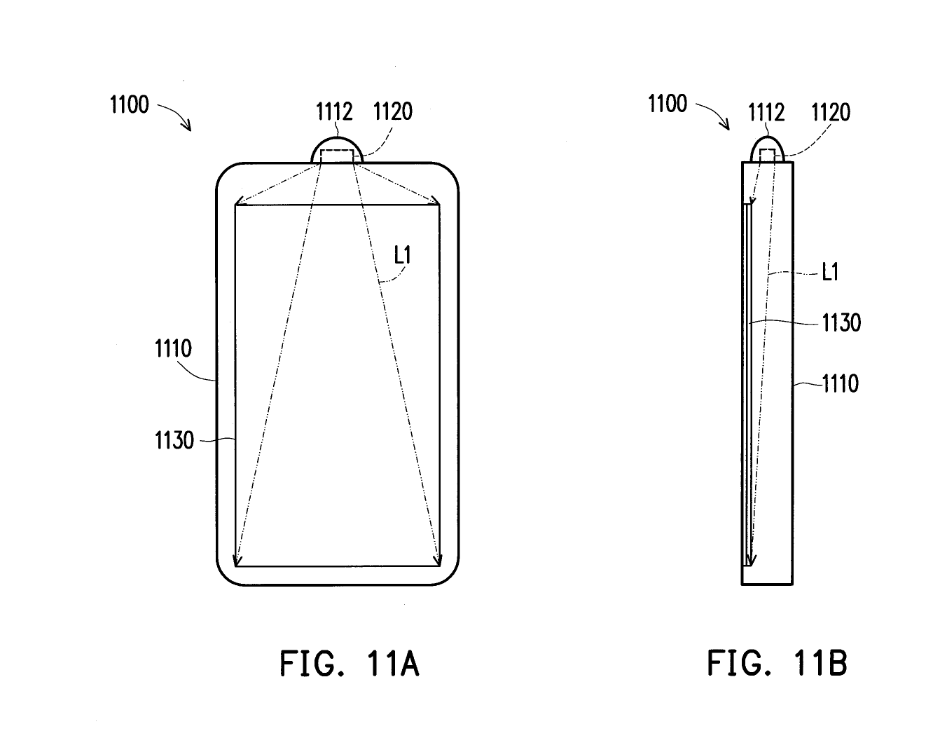

FIG. 11A is a schematic front view illustrating a portable display device according to an eleventh embodiment of the invention. FIG. 11B is a schematic cross-sectional view illustrating the portable display device depicted in FIG. 11A. With reference to FIG. 11A and FIG. 11B, in order to increase the length of the optical path of the first image light beam L1, one side of the casing 1110 is designed to be a protrusion 1112 where the pico-projection module 1120 is accommodated. Thereby, the distance from the pico-projection module 1120 to the first display screen 1130 is extended, and thus the length of the optical path of the first image light beam L1 is increased.

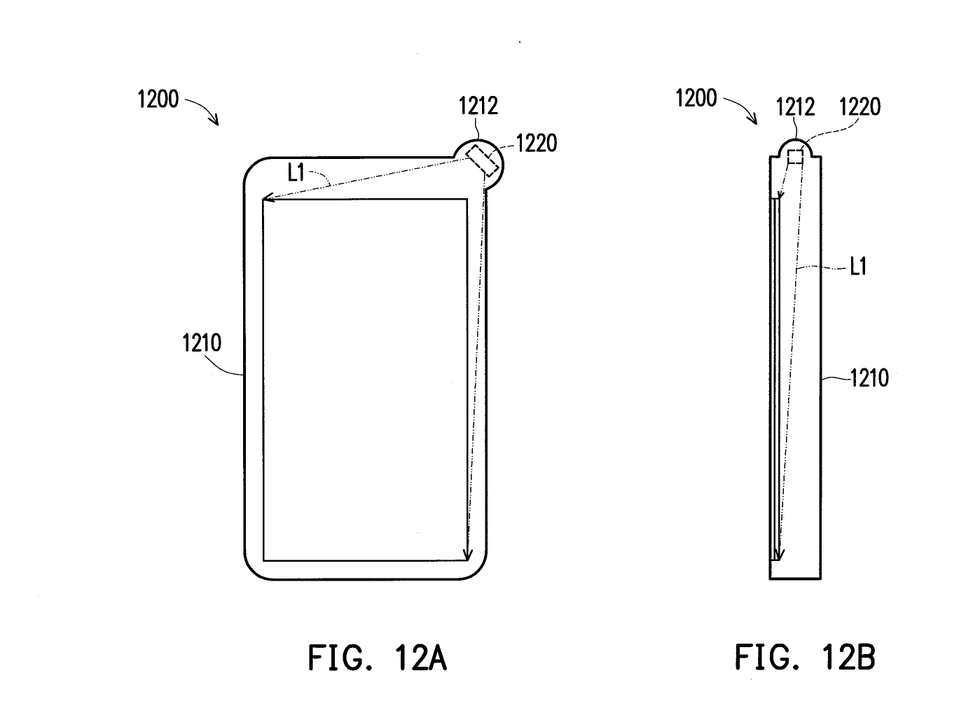

FIG. 12A is a schematic front view illustrating a portable display device according to a twelfth embodiment of the invention. FIG. 12B is a schematic cross-sectional view illustrating the portable display device depicted in FIG. 12A. With reference to FIG. 12A and FIG. 12B, one of the differences between the portable display device 1200 described in the embodiment and the portable display device 1100 shown in FIG. 11A lies in that the protrusion 1112 and the pico-projection module 1120 in FIG. 11A are located at the center of one side of the casing 1110. In the embodiment, however, the protrusion 1212 and the pico-projection module 1220 are located in a corner of the casing 1210. Certainly, the locations of the protrusion 1212 and the pico-projection module 1220 are not limited to those described above.

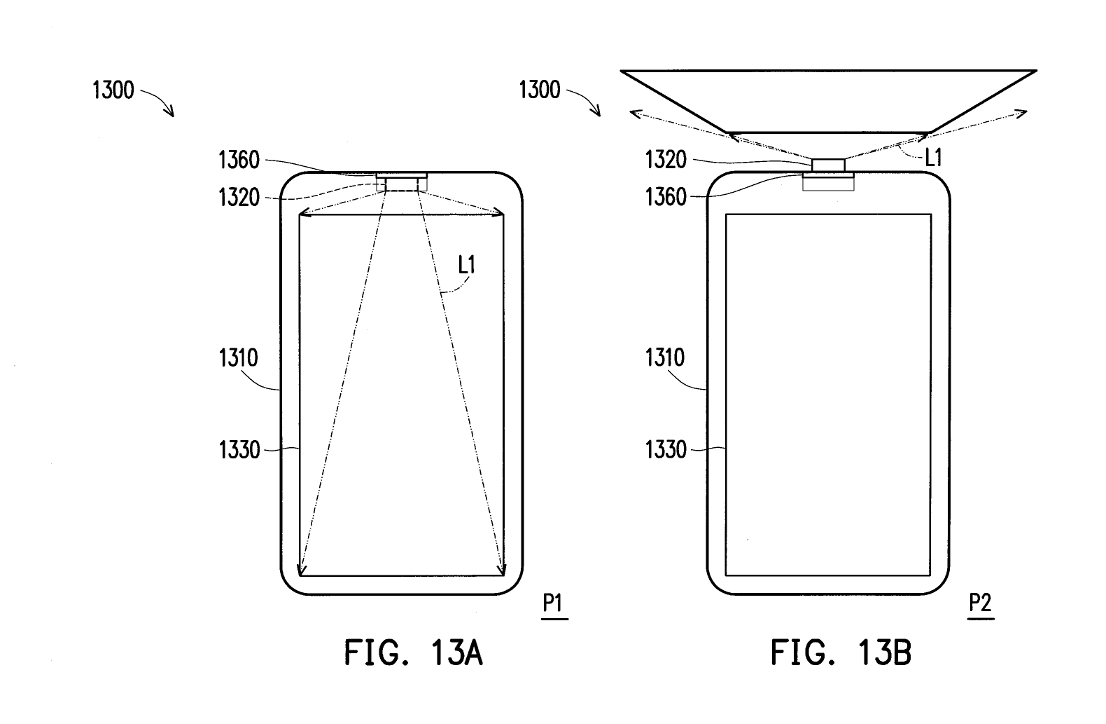

FIG. 13A is a schematic view illustrating that a pico-projection module of a portable display device projects an image light beam to a first display screen according to a thirteenth embodiment of the invention. FIG. 13B is a schematic view illustrating that the pico-projection module of the portable display device depicted in FIG. 13A projects an image light beam to the outside of a casing. With reference to FIG. 13A and FIG. 13B, in the embodiment, the portable display device 1300 further includes a steering component 1360 in order to share an image with others. The pico-projection module 1320 is rotatably connected to the casing 1310 through the steering component 1360, such that the pico-projection module 1320 is configured to rotate to an inner projection location P1 and an outer projection location P2.

As shown in FIG. 13A, when the pico-projection module 1320 rotates to the inner projection location P1, the first image light beam L1 projected from the pico-projection module 1320 is projected onto the first display screen 1330. By contrast, as shown in FIG. 13B, when the pico-projection module 1320 rotates to the outer projection location P2, the first image light beam L1 projected from the pico-projection module 1320 is projected onto an object outside the casing 1310. The object may be a wall, a ceiling, an external screen, or any other projectable surface. Hence, based on actual requirements, a user may rotate the pico-projection module 1320 to any angle relative to the casing 1310.

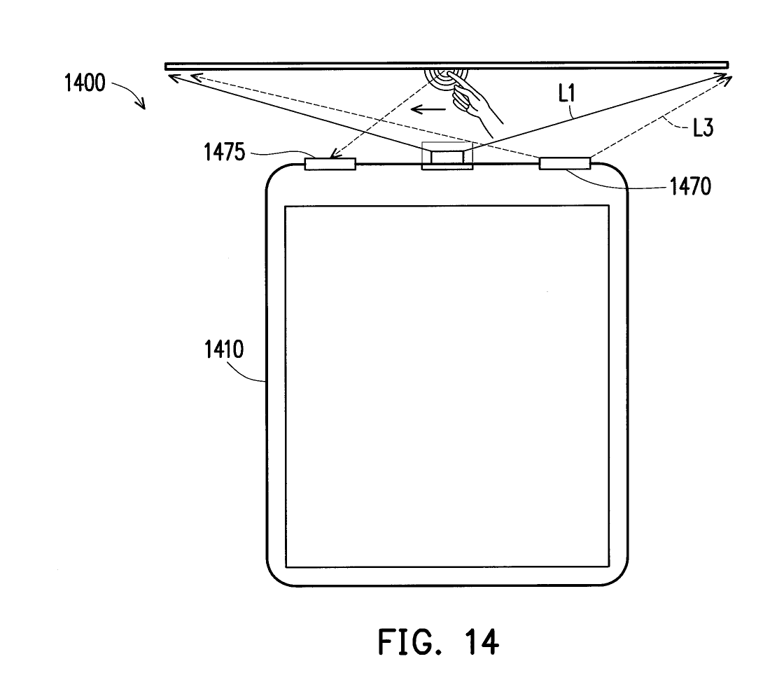

FIG. 14 is a schematic front view illustrating a portable display device according to a fourteenth embodiment of the invention. With reference to FIG. 14, in order to touch-control the image projected outside the casing 1410 by means of gestures or the like, the portable display device 1400 described in the embodiment further includes a light emitter 1470 and a light receiver 1475. The light emitter 1470 is capable of emitting a third light beam L3 to a region, and the first image light beam L1 is projected on the region located outside the casing 1410. The light receiver 1475 is capable of sensing a change of the third light beam L3 to obtain a location of an object relative to the region where the first image light beam L1 is projected. In the embodiment, the third light beam L3 is an invisible light beam, e.g., an infrared light beam, such that the third light beam L3 does not interfere with the image created by the projected first image light beam L1. However, note that the type of the third light beam L3 is not limited in the invention.

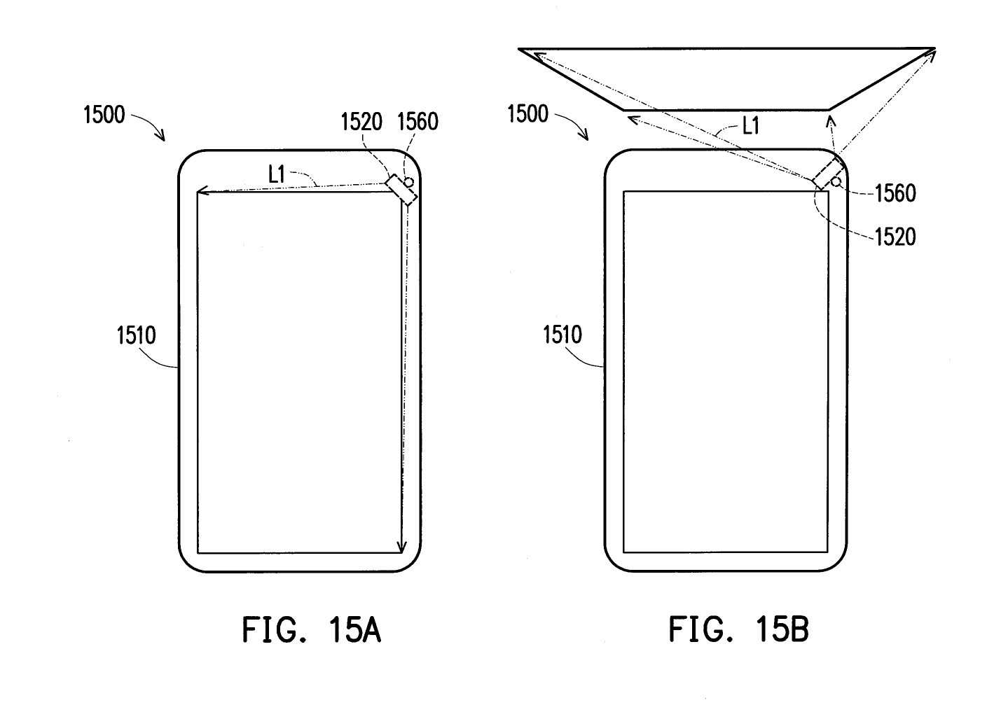

FIG. 15A is a schematic view illustrating that a pico-projection module of a portable display device projects an image light beam to a first display screen according to a fifteenth embodiment of the invention. FIG. 15B is a schematic view illustrating that the pico-projection module of the portable display device depicted in FIG. 15A projects an image light beam to the outside of a casing. With reference to FIG. 15A and FIG. 15B, one of the differences between the portable display device 1500 described in the embodiment and the portable display device 1300 shown in FIG. 13A lies in that the pico-projection module 1320 and the steering component 1360 in FIG. 13A are located on one inner side of the casing 1310. In the embodiment, however, the pico-projection module 1520 and the steering component 1560 are located in a corner of the casing 1510. Certainly, the locations of the pico-projection module 1520 and the steering component 1560 relative to the casing 1510 are not limited to those provided above.

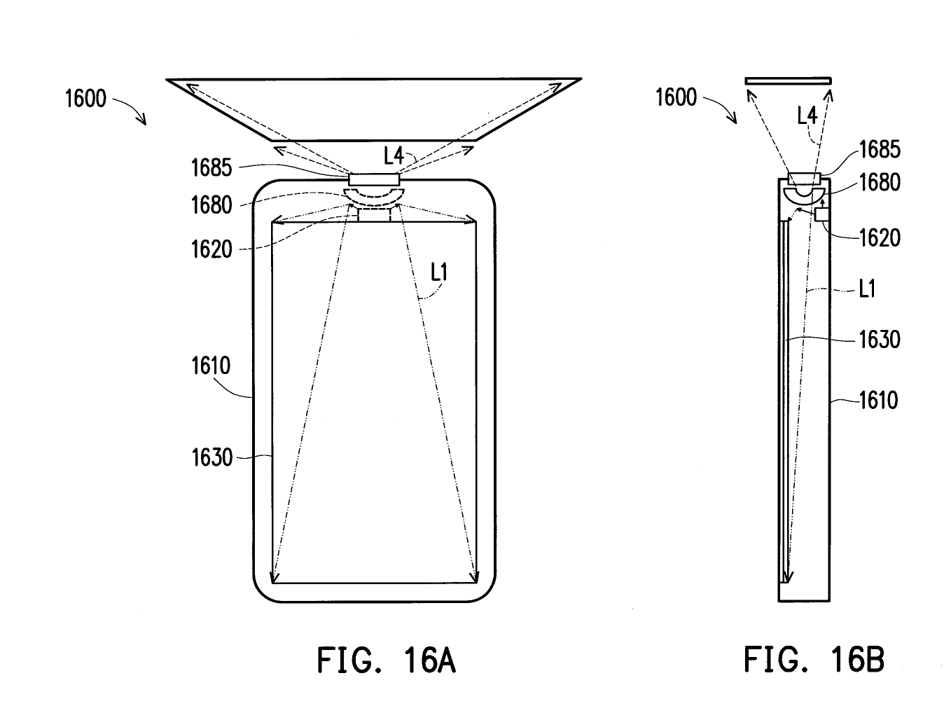

FIG. 16A is a schematic view illustrating that a pico-projection module of a portable display device projects an image light beam to a first display screen and to the outside of a casing according to a sixteenth embodiment of the invention. FIG. 16B is a schematic cross-sectional view illustrating the portable display device depicted in FIG. 16A. With reference to FIG. 16A and FIG. 16B, in the embodiment, the portable display device 1600 further includes a polarizing beam splitter (PBS) 1680 and an optical compensation element 1685. The PBS 1680 described herein is a polarizing beam splitting convex mirror that is coated with a polarizing material. Certainly, in another embodiment of the invention, the PBS 1680 may be a polarizing beam splitting prism, and the type of the PBS 1680 should not be construed as a limitation to the invention.

According to the embodiment, the pico-projection module 1620 may merely project the first image light beam L1 or alternately project the first image light beam L1 and a fourth image light beam L4. Here, a polarization state of the first image light beam L1 is different from a polarization state of the fourth image light beam L4. Here, the first image light beam L1 and the fourth image light beam L4 have different polarization directions, e.g., an S-polarized light and a P-polarized light of which the polarization directions are perpendicular to each other. However, the type of the first image light beam L1 and the fourth image light beam L4 is not limited to that described herein.

Normally, if an image is merely required to be viewed on the first display screen 1630, the pico-projection module 1620 merely projects the first image light beam L1, and the PBS 1680 may reflect the first image light beam L1 to the first display screen 1630 and thereby form an image on the first display screen 1630.

Nevertheless, if it is required to project the image onto the first display screen 1630 and a region outside the casing 1610, the pico-projection module 1620 may alternately project the first image light beam L1 and the fourth image light beam L4. The first image light beam L1 is reflected by the PBS 1680 to the first display screen 1630, and the fourth image light beam passes through the PBS 1680 and is then projected outside the casing 1610. Thereby, the portable display device 1600 described in the embodiment allows the image to be simultaneously displayed on the first display screen 1630 and on an object outside the casing 1610.

The optical compensation element 1685 described herein is located on an optical path of the fourth image light beam L4 after the fourth image light beam L4 passes through the PBS 1680. When the fourth image light beam L4 is projected out of the casing 1610, the optical compensation element 1685 is capable of compensating the resultant image aberration or enlarging the resultant image. For instance, the optical compensation element 1685 may be an anamorphic lens or a combination of lenses, which should however not be construed as a limitation to the invention. Certainly, in another embodiment, the optical compensation element 1685 may be replaced by software capable of compensation.

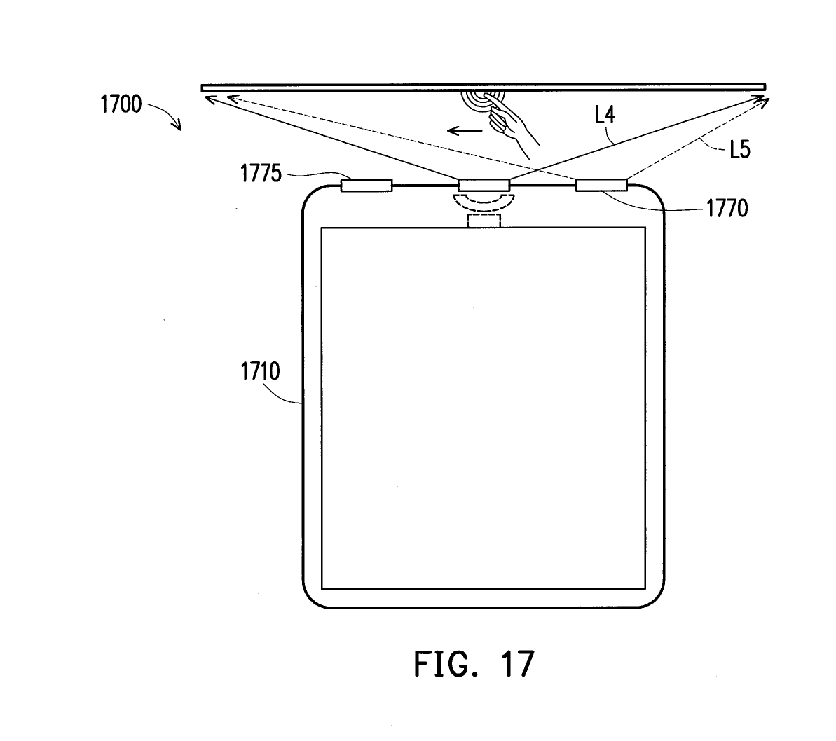

FIG. 17 is a schematic front view illustrating a portable display device according to a seventeenth embodiment of the invention. With reference to FIG. 17, in order to touch-control the image projected outside the casing 1710 by means of gestures or the like, one of the differences between the portable display device 1700 described in the embodiment and the portable display device 1600 shown in FIG. 16A lies in that the portable display device 1700 described herein further includes a light emitter 1770 and a light receiver 1775. The light emitter 1770 is capable of emitting a fifth light beam L5 to a region, and the fourth image light beam L4 is projected on the region located outside the casing 1710. The light receiver 1775 is capable of sensing a change of the fifth light beam L5 to obtain a location of an object relative to the region where the fourth image light beam L4 is projected. In the embodiment, the fifth light beam L5 is an invisible light beam, e.g., an infrared light beam, such that the fifth light beam L5 does not interfere with the image created by the projected fourth image light beam L4. However, note that the type of the fifth light beam L5 is not limited in the invention.

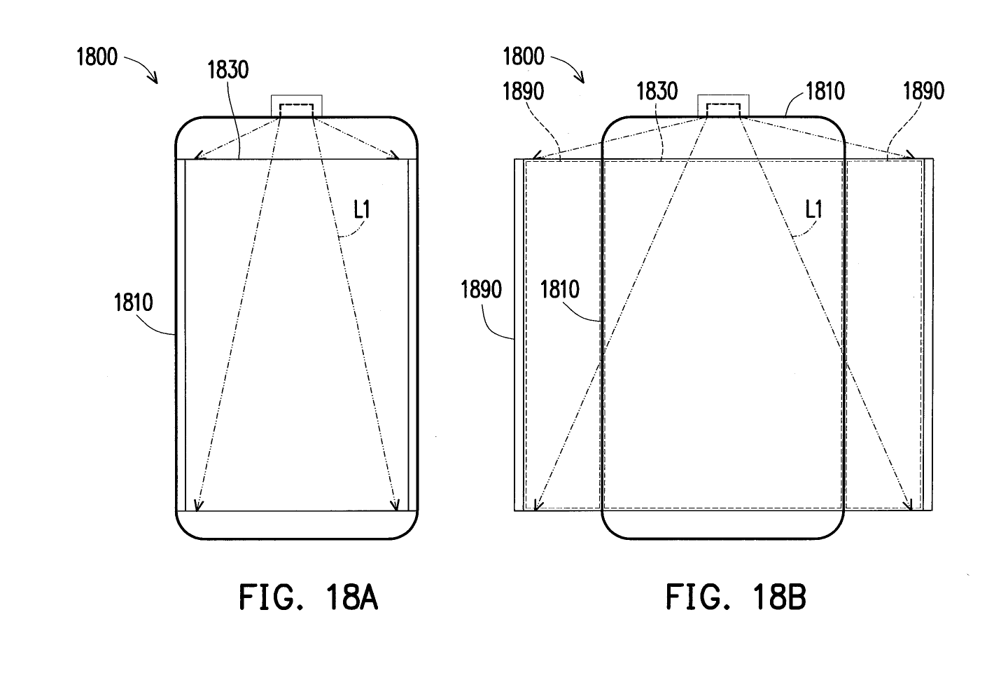

FIG. 18A is a schematic view illustrating that a second display screen of a portable display device is accommodated in a casing according to an eighteenth embodiment of the invention. FIG. 18B is a schematic view illustrating that the second display screen of the portable display device depicted in FIG. 18A is unfolded out of the casing. With reference to FIG. 18A and FIG. 18B, in order to provide a rather large physical display screen, the portable display device 1800 described in the embodiment further includes at least one second display screen 1890 that is configured to be accommodated in the casing 1810 or unfolded out of the casing 1810.

As shown in FIG. 18A, under normal circumstances, a user merely views an image on the first display screen 1830; at this time, the second display screen 1890 may be accommodated in the casing 1810. In order to accommodate the second display screen 1890 in the casing 1810, the second display screen 1890 may be rolled up as a scroll, may be directly bent, or may slide on one direction so as to be overlapped with the first display screen 1830 when the second display screen 1890 is accommodated. Note that the way to accommodate the second display screen 1890 in the casing 1810 should not be construed as a limitation to the invention.

If the user is in need of a large physical display screen, as shown in FIG. 18, the second display screen 1890 may be unfolded out of the casing 1810 and located at the two sides of the first display screen 1830, and the first image light beam L1 may then be projected onto both the first display screen 1830 and the second display screen 1890. By means of the foldable second display screen 1890, the portable display device 1800 described herein allows the size of the physical display screen to be enlarged.

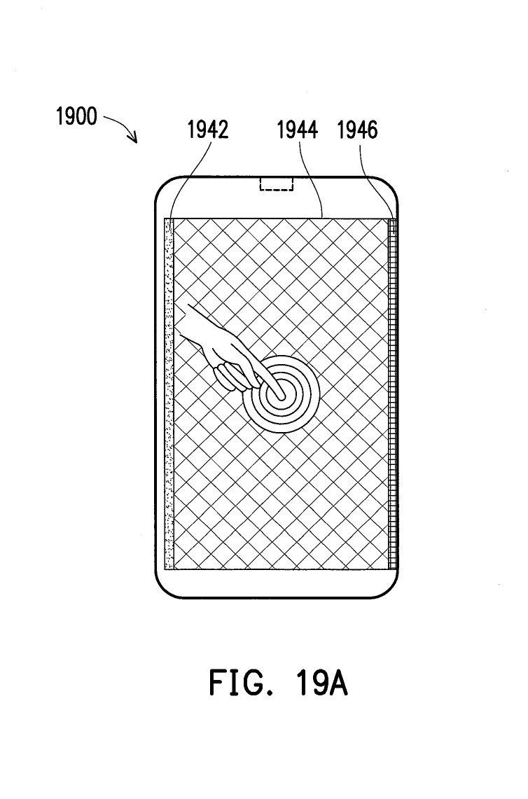

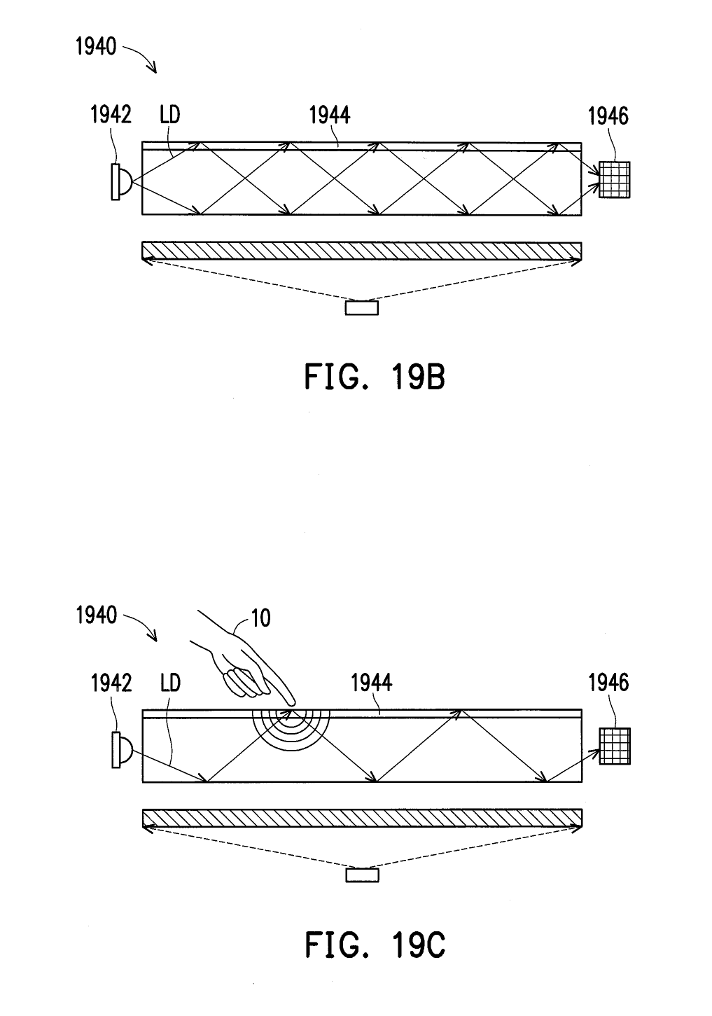

FIG. 19A is a schematic front view illustrating a portable display device according to a nineteenth embodiment of the invention. FIG. 19B and FIG. 19C are schematic views illustrating an operation of the touch module of the portable display device depicted in FIG. 19A. With reference to FIG. 19A to FIG. 19C, one of the differences between the touch module 1940 of the portable display device 1900 described in the embodiment and the touch module 140 shown in FIG. 1D lies in that the touch module 140 in FIG. 1D is a capacitive touch module. In the embodiment, however, the touch module 1940 is an optical waveguide touch module. Here, the touch module 1940 includes a light emitter 1942, a light guide plate (LGP) 1944, and a light detector 1946. The light emitter 1942 is capable of emitting a detection light beam LD. The LGP 1944 is located on a transmission path of the detection light beam LD. The light detector 1946 is located on a transmission path of the detection light beam LD from the LGP 1944. When an object 10 (e.g., a human finger) is in contact with the touch module 1940, the object 10 changes the detection light beam LD transmitted in the LGP 1944, thus resulting in frustrated total internal reflection (FTIR). The light detector 1946 then detects the detection light beam LD changed by the object 10 to obtain the location of the object 10.

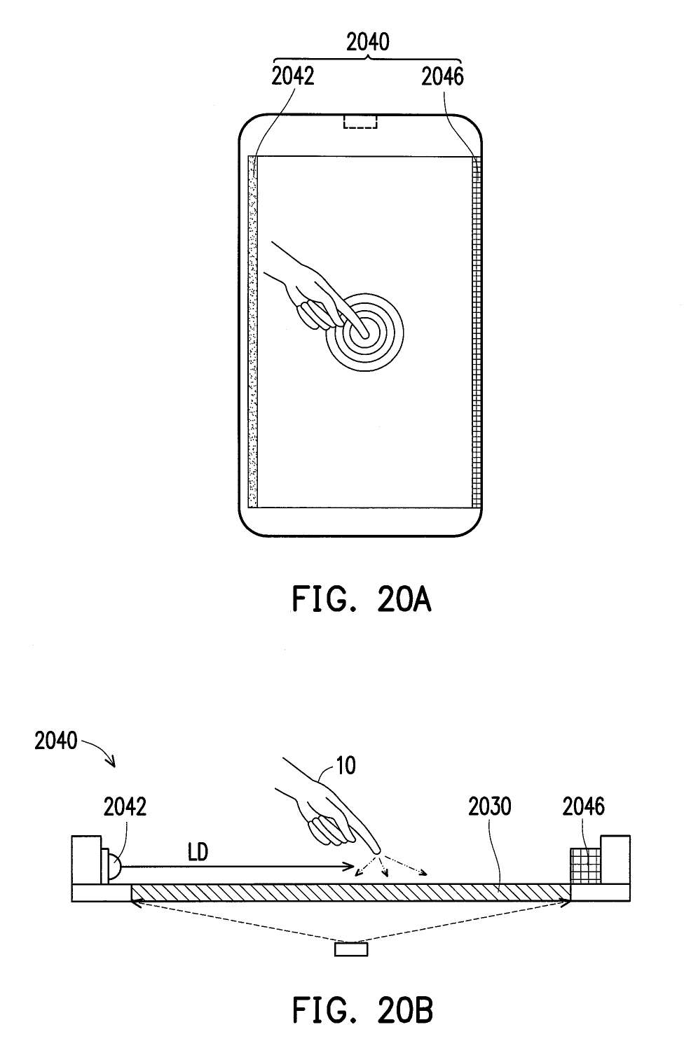

FIG. 20A is a schematic front view illustrating a portable display device according to a twentieth embodiment of the invention. FIG. 20B is a schematic view illustrating an operation of the touch module of the portable display device depicted in FIG. 20A. With reference to FIG. 20A and FIG. 20B, according to the embodiment, the touch module 2040 is an optical curtain touch module and includes a light emitting module 2042 and a light reception module 2046. The light emitting module 2042 is located on one side of the first display screen 2030 and emits a detection light beam LD transmitted in front of the first display screen 2030. The light reception module 2046 is located on another side of the first display screen 2030 and is capable of receiving the detection light beam LD. As shown in FIG. 20B, when an object 10 (e.g., a human finger) is in contact with or approaches the first display screen 2030, the object 10 blocks the detection light beam LD passing through the touch location or the location where the object 10 approaches. Thereby, the light reception module 2046 corresponding to the dark spot cannot receive the expected detection light beam LD, such that the relative location of the object 10 on the first display screen 2030 may be determined.

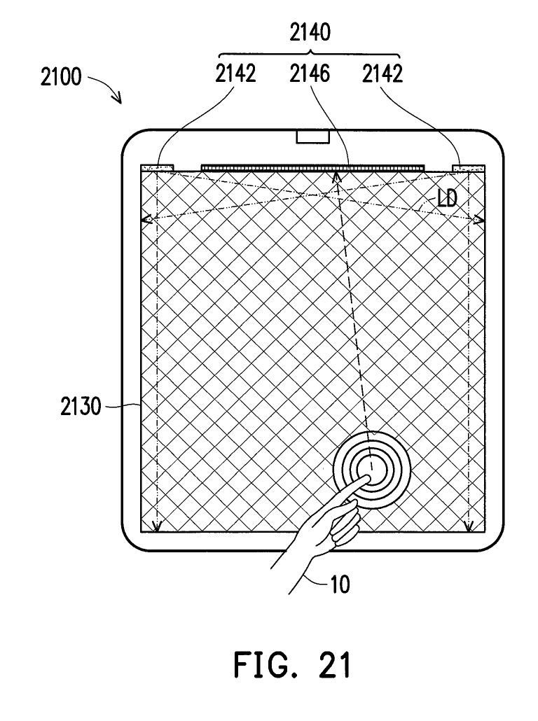

FIG. 21 is a schematic view illustrating a portable display device according to a twenty-first embodiment of the invention. With reference to FIG. 21, according to the embodiment, the touch module 2140 of the portable display device 2100 is an optical scanning touch module and includes at least one scanner light source 2142 and a light receiver 2146. Here, the touch module 2140 includes two scanner light sources 2142 which are laser light sources. Each of the scanner light sources 2142 is located next to the first display screen 2130 and is capable of emitting a detection light beam LD, and the detection light beam LD serves to scan the space in front of the first display screen 2130. The light receiver 2146 is located next to the first display screen 2130, as shown in FIG. 21. In the embodiment, the two scanner light sources 2142 and the light receiver 2146 are located on the same side of the first display screen 2130, while the locations of the scanner light sources 2142 and the light receiver 2146 should not be construed as limitations to the invention. Besides, the light receiver 2146 is capable of detecting the detection light beam LD from the space in front of the first display screen 2130. When an object (e.g., a human finger) is in contact with or approaches the first display screen 2130, the light receiver 2146 detects the detection light beam LD reflected by the object, so as to obtain the relative location of the object on the first display screen 2130.

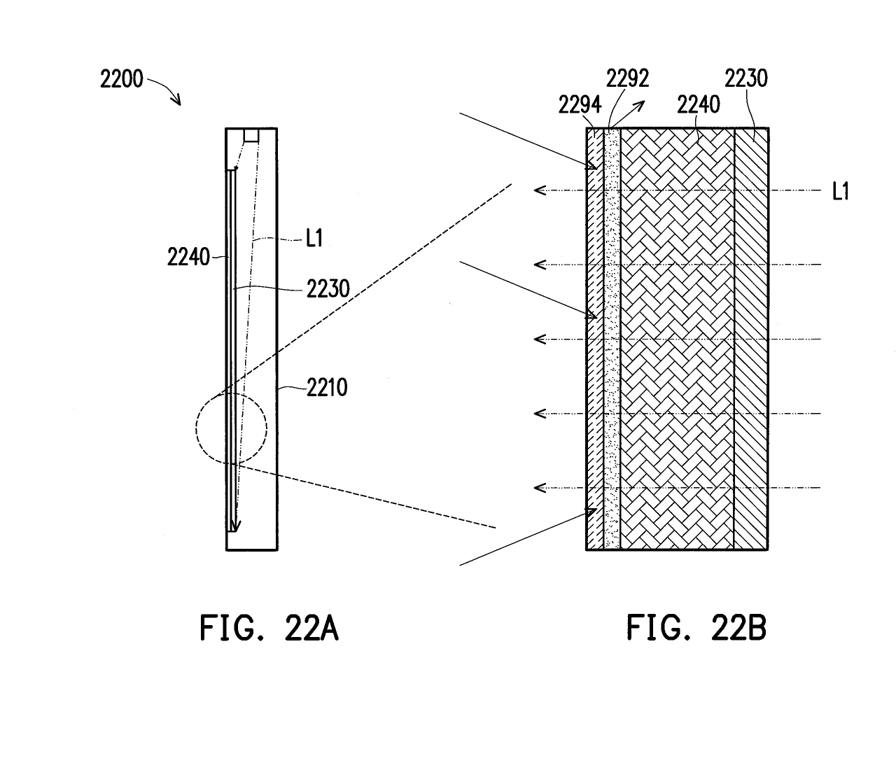

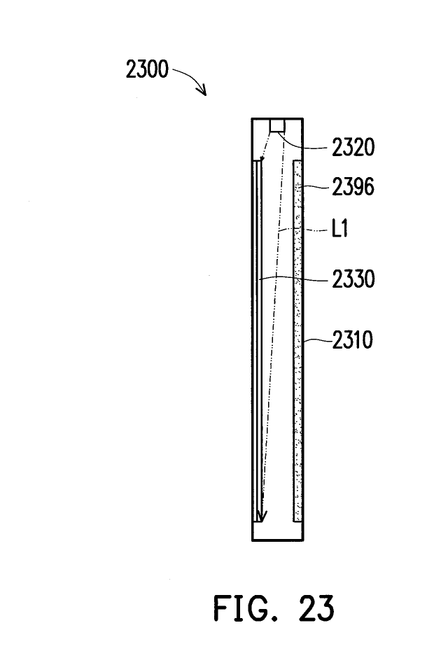

FIG. 22A is a schematic side view illustrating a portable display device according to a twenty-second embodiment of the invention. FIG. 22B is a schematic partial cross-sectional view illustrating the portable display device depicted in FIG. 22A. With reference to FIG. 22A and FIG. 22B, in the embodiment, the portable display device 2200 further includes a transparent solar panel 2292 that is located on one side of the casing 2210 close to the first display screen 2230. As shown in FIG. 22B, the touch module 2240 is located next to the first display screen 2230, the transparent solar panel 2292 is located next to the touch module 2240, and a transparent cover plate 2294 is located next to the transparent solar panel 2292. In the embodiment, the transparent solar panel 2292 is located on a transmission path of the first image light beam L1. Since the transmittance ratio of the transparent solar panel 2292 may reach 90%, the transparent solar panel 2292 does not pose any significant impact on blocking the first image light beam L1. Instead, when the first image light beam L1 is imaged on the first display screen 2230, the transparent solar panel 2292 may simultaneously absorb energy, so as to supply power to the portable display device 2200.

FIG. 23 is a schematic cross-sectional view illustrating a portable display device according to a twenty-third embodiment of the invention. With reference to FIG. 23, one of the differences between the portable display device 2300 described in the embodiment and the portable display device 2200 shown in FIG. 22A lies in that the solar panel 2396 described herein is located on an inner side of the casing 2310 opposite to the first display screen 2330. Since the solar panel 2396 is not located on the transmission path of the first image light beam L1, the solar panel 2396 may not be characterized by transparency. In the embodiment, the solar panel 2396 may absorb both the external ambient light entering the casing 2310 from the first display screen 2330 and the stray light generated when the pico-projection module 2320 projects the image light beam, and the absorbed light may be converted into power to be supplied to the portable display device 2300.

To sum up, in the portable display device, the pico-projection module located in the casing projects an image onto the display screen, and thereby the conventional backlight module and the conventional liquid crystal module may be replaced. As such, the resultant portable display device described herein may have light weight, low power consumption, and reduced manufacturing costs in comparison with the conventional portable display device. In addition, the pico-projection module of the portable display device may rotate relative to the casing by means of the steering component, such that the user may select to project the image light beam onto the display screen or onto an object outside the casing. In case that the image light beam is projected onto the object outside the casing, the portable display device is able to provide a touch function on the object where the image light beam is projected. The PBS of the portable display device allows the pico-projection module to alternately project the image light beam onto the display screen and onto an object outside the casing, and thereby the user is able to view the resultant image on both the display screen and on the object outside the casing. Moreover, the portable display device described herein may also be equipped with the second display screen that is accommodated in the casing or unfolded out of the casing, and thus the size of the physical display screen may be adjusted according to the actual user's requirements. Last but not least, the solar panel of the portable display device may store energy by absorbing external light, a small amount of light from the pico-projection module, and the scattered light within the casing, so as to generate power and supply the same to the portable display device.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A portable display device comprising:
a casing;
a pico-projection module located in the casing, the pico-projection module being capable of providing a first image light beam;
a first display screen located on the casing, the pico-projection module being configured to project the first image light beam onto the first display screen; and
a touch module located on the first display screen.

2. The portable display device as recited in claim 1, wherein the first image light beam from the pico-projection module is transmitted in the casing to the first display screen.

3. The portable display device as recited in claim 1, wherein the pico-projection module comprises:
an illumination system capable of emitting an illumination light beam, the illumination system comprising a light emitting diode, a laser source, or a composite light source having the laser source and a fluorescent module;
a light valve located on a transmission path of the illumination light beam to convert the illumination light beam into the first image light beam, wherein the first image light beam is an image light beam; and
an imaging lens located on a transmission path of the first image light beam and between the light valve and the first display screen.

4. The portable display device as recited in claim 1, wherein the pico-projection module comprises:
a light source module capable of emitting the first image light beam; and
a scanner module located on a transmission path of the first image light beam, the scanner module being capable of scanning the first image light beam onto different locations on the first display screen.

5. The portable display device as recited in claim 4, wherein the light source module comprises a laser light source.

6. The portable display device as recited in claim 1, wherein the first display screen comprises a combination of a Fresnel lens and a lenticular lens array, a diffuser plate, or a diffractive plate.

7. The portable display device as recited in claim 1, wherein the first display screen comprises a fluorescent layer, and the first image light beam excites the fluorescent layer when the first image light beam irradiates the fluorescent layer, so as to generate a second image light beam.

8. The portable display device as recited in claim 1, wherein thickness of the casing at locations from one end of the casing close to the pico-projection module to the other end of the casing away from the pico-projection module remains substantially the same, or the thickness of the casing gradually decreases from the one end of the casing close to the pico-projection module to the other end of the casing away from the pico-projection module.

9. The portable display device as recited in claim 1, further comprising a reflection element capable of reflecting the first image light beam from the pico-projection module to the first display screen.

10. The portable display device as recited in claim 9, wherein a thickness of the casing gradually decreases from one end of the casing close to the reflection element to the other end of the casing close to the pico-projection module.

11. The portable display device as recited in claim 9, wherein the pico-projection module and the reflection element are located on two opposite inner sides or on one inner side of the casing.

12. The portable display device as recited in claim 11, wherein the reflection element is a plane mirror, a convex mirror, a concave mirror, a columnar convex mirror, or a columnar concave mirror.

13. The portable display device as recited in claim 1, wherein the casing comprises a protrusion, and the pico-projection module is located in the protrusion.

14. The portable display device as recited in claim 1, wherein the pico-projection module is located on one inner side of the casing or in an inner corner of the casing.

15. The portable display device as recited in claim 1, further comprising a steering component, the pico-projection module being rotatably connected to the casing through the steering component and configured to rotate to an inner projection location and an outer projection location, wherein when the pico-projection module rotates to the inner projection location, the first image light beam from the pico-projection module is projected onto the first display screen, and when the pico-projection module rotates to the outer projection location, the first image light beam from the pico-projection module is projected out of the casing.

16. The portable display device as recited in claim 15, further comprising a light emitter and a light receiver, the light emitter being capable of emitting a third light beam to a region out of the casing, the first image light beam being projected onto the region out of the casing, the light receiver being capable of sensing a change of the third light beam to obtain a location of an object relative to the region.

17. The portable display device as recited in claim 1, further comprising a polarizing beam splitter, the pico-projection module being configured to alternately project the first image light beam and a fourth image light beam, a polarization state of the first image light beam being different from a polarization state of the fourth image light beam, the first image light beam being reflected by the polarizing beam splitter to the first display screen, the fourth image light beam being projected out of the casing after passing through the polarizing beam splitter.

18. The portable display device as recited in claim 17, further comprising an optical compensation element, wherein the fourth image light beam from the polarizing beam splitter is transmitted through the optical compensation element and projected out of the casing, and the optical compensation element is capable of compensating image aberration generated when the fourth image light beam is projected out of the casing.

19. The portable display device as recited in claim 17, further comprising a light emitter and a light receiver, the light emitter being capable of emitting a fifth light beam to a region out of the casing, the fourth image light beam being projected onto the region out of the casing, the light receiver being capable of sensing a change of the fifth light beam to obtain a location of an object relative to the region.

20. The portable display device as recited in claim 1, further comprising a second display screen configured to be accommodated in the casing or unfolded out of the casing, wherein when the second display screen is accommodated in the casing, the pico-projection module projects the first image light beam to the first display screen, and when the second display screen is unfolded out of the casing, the first image light beam is projected onto the first display screen and the second display screen.

21. The portable display device as recited in claim 1, wherein the touch module is a capacitive touch panel.

22. The portable display device as recited in claim 1, wherein the touch module is an optical waveguide touch module and comprises:
a light emitter capable of emitting a detection light beam;
a light guide plate located on a transmission path of the detection light beam; and
a light detector located on the transmission path of the detection light beam from the light guide plate, wherein when an object is in contact with the optical waveguide touch module, the object changes the detection light beam transmitted in the light guide plate, and the light detector detects the detection light beam changed by the object.

23. The portable display device as recited in claim 1, wherein the touch module is an optical curtain touch module and comprises:
a light emitting module located on one side of the first display screen, the light emitting module emitting a detection light beam transmitted in front of the first display screen; and
a light reception module located on another side of the first display screen, the light reception module being capable of receiving the detection light beam.

24. The portable display device as recited in claim 1, wherein the touch module is an optical scanning touch module and comprises:
at least one scanner light source located next to the first display screen, the at least one scanner light source being capable of emitting a detection light beam, wherein the detection light beam scans space in front of the first display screen; and
a light receiver located next to the first display screen to detect the detection light beam from the space in front of the first display screen, wherein when an object is in contact with or approaches the first display screen, the light receiver detects the detection light beam reflected by the object.

25. The portable display device as recited in claim 1, further comprising a transparent solar panel located on one side of the first display screen and on a transmission path of the first image light beam.

26. The portable display device as recited in claim 1, further comprising a solar panel located on an inner side of the casing opposite to the first display screen.
